(19) United States
(12) Patent Application Publication
(10) Pub. No.: US 2002/0100623 A1
(43) Pub. Date: Aug. 1, 2002

(54) Self propelling bicycle trailer

(76) Inventor: Richard E. Thornton, St. Charles, MO (US)

Correspondence Address: Matthew J. Peirce, Esq., 601 S. Rancho Drive, # A-10, Las Vegas, NV, 89106, US

(21) Appl. No.: 09/771,234

(22) Filed: Jan. 29, 2001

(51) Int. Cl. B60K 1/00

(52) U.S. Cl. 180/65.2; 180/204

(57) ABSTRACT

The present invention comprises an innovative one-wheel trailer device with an included motor that is designed to be attached to a bicycle. The present invention assists a rider in the propulsion of the bicycle. The components of the present invention are to be physically located on a separate trailer which is attached to the bike, thereby reducing the weight and bulk attached to the bicycle. The present invention comprises a frame, upon which the motor, drive train and wheel are attached. The framework is designed to attach to the bicycle at each side of the rear wheel, and to the top of the seat post. The component connecting to the seat post would have a special plastic fitting that would not only prevent damage to the bicycle's frame, but would also adjust to allow for dimension variations from one bicycle to another. This frame member would also have an incorporated parking brake, which would consist of a bar which swings down and engages against the bicycle's rear tire, in order to prevent the wheel from rotating. The brake can be adjusted to accommodate different size bicycle wheels.

The frame would have an incorporated U-joint located directly in front of the trailer wheel, which would allow the trailer to swivel in the horizontal and vertical axis. The trailer can not turn on the longitudinal axis which permits the use of only one wheel on the trailer. The U-joint would be designed to quickly and easily attach and detach from the trailer frame assembly, so that the trailer can be easily disconnected from the bike when desired. This permits the framework to remain attached to the bicycle. The single wheel would be positioned in the middle of the trailer's frame so that it rides in the same path as do the bicycle wheels, which would result in the bicycle being neutrally balanced.

### I BACKGROUND OF THE INVENTION

The present invention relates to that of a bicycle trailer, and more specifically relates to a bicycle trailer which includes either an incorporated gasoline engine or a battery-powered electric motor that would attach to a bicycle to assist in propulsion of the bicycle as a bicycle would be used.

### II. DESCRIPTION OF THE PRIOR ART

U.S. Pat. No. 5,842,535, issued to Dennis, discloses an electric drive assembly for driving a bicycle which includes an electric power pack containing a battery or batteries, and electric motor, a drive wheel, a control circuit, a re-charger and an electric switch and a common housing.

U.S. Pat. No. 4,386,675, issued to Landon, discloses a drive means which includes an electric motor which is pivoted in a substantially balanced position by a biasing means above a wheel of a vehicle.

U.S. Pat. No. 4,280,581, issued to Rudwick, discloses an electrically assisted bicycle, which includes a modified elongated frame, such that the storage battery and motor may be mounted at a low level between the pedals and the rear wheel for a more stable and smooth ride and to lessen the likelihood of wheel hop.

U.S. Pat. No. 4,276,950, issued to Vance, discloses a power assisted pedicycle.

U.S. Pat. No. 4,183,418, issued to Dudas, discloses a tricycle apparatus which utilizes a chassis having a housing disposed surrounding the midregions of the rear axle of the tricycle.

U.S. Pat. No. 3,598,195, issued to Steller, discloses a tricycle with a battery powered drive motor as well as pedal operated drive means so connected that either of the drive means may be used alone or may be used in combination to supplement each other.

### III. SUMMARY OF THE INVENTION

The present invention comprises an innovative one-wheel trailer device with an included motor that is designed to be attached to a bicycle. The present invention assists a rider in the propulsion of the bicycle. The components of the present invention are physically located on a separate trailer which is attached to the bike, thereby reducing the weight and bulk attached to the bicycle. The present invention comprises a framework, upon which the motor, drive train and wheel are attached. The framework is designed to attach to the bicycle at each side of the rear wheel, and to the top of the seat post. The component connecting to the seat post would have a special plastic fitting that would not only prevent damage to the bicycle's frame, but would also adjust to allow for dimension variations from one bicycle to another. This frame member would also have an incorporated parking brake, which would comprise of a bar which swings down and engages against the rear bicycle tire, in order to prevent the wheel from rotating. The brake can be adjusted to accommodate different size bicycle wheels.

The frame would have an incorporated U-joint located directly in front of the trailer wheel, which would allow the trailer to swivel in the horizontal and vertical axis. The trailer can not turn on the longitudinal axis, which permits the use of only one wheel on the trailer. The U-joint would be designed to quickly and easily attach and detach from the trailer frame assembly, so that the trailer can be easily disconnected from the bike when desired. This permits the framework to remain attached to the bicycle. The single wheel would be positioned in the middle of the trailer's frame so that it rides in the same path as do the bicycle wheels, which would result in the bicycle being neutrally balanced.

The power source of the present invention can be an internal combustion engine or battery powered electric motor. The power source would be controlled by a special “command unit” which would attach to the bicycle's handlebar. Speed, gear selection, and other such controls would be controlled by this command unit by means of electrical wires or cables.

The U-joint connecting the drive unit to the bicycle would be permitted to rotate along the horizontal and vertical axis, thereby permitting the trailer to remain upon the surface while the bicycle is leaning into a corner. With the trailer's wheel on the same tracking path as the bicycle's wheels, the bicycle's trailer assembly can accelerate and decelerate in a straight line with acceptable lateral force factors. When accelerating or decelerating on a curved path, lateral force factors do not pose a major handling issue until the angle at the U-joint exceeds 30 degrees with the one or two-horse power motor and drive train propulsion at full power.

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regard as including such equivalent constructions insofar as they do not depart from the spirit and scope of the present invention.

It is therefore an object of the present invention to provide a new and improved bicycle trailing device which has all of the advantages of the prior art and none of the disadvantages.

It is therefore an object of the present invention to provide a new and improved bicycle trailing device which may be easily and efficiently manufactured and marketed.

It is therefore an object of the present invention to provide a new and improved bicycle trailing device which is of durable and reliable construction.

It is yet another object of the present invention to provide a new and improved bicycle trailing device which is economically affordable and available to the buying public.

It is yet still another object of the present invention to provide a new and improved bicycle trailing device which can provide extra power to a bicycle with very little extra energy needed.

Other objects, features and advantages of the present invention will become more readily apparent from the following detailed description of the preferred embodiment when considered with the attached drawings and appended claims.

### IV. BRIEF DESCRIPTION OF THE DRAWINGS

FIGS. 1 and 2 show top and side views, respectively, of the U-joint.

FIGS. 3 and 4 show side and top views, respectively, of seat post clamp 18.

FIG. 5 shows a top view of a gasoline engine configuration.

FIG. 6 is a perspective view of the electrical motor configuration.

FIG. 7 is a representative schematic view of the control circuit which would be located on the handlebars of a bicycle associated with the present invention.

FIG. 8 is a perspective view of the entire trailer of the present invention.

FIGS. 9 and 10 illustrate alternative embodiments of drive wheel 5 and associated components of the present invention.

### V. DESCRIPTION OF THE PREFERRED EMBODIMENT

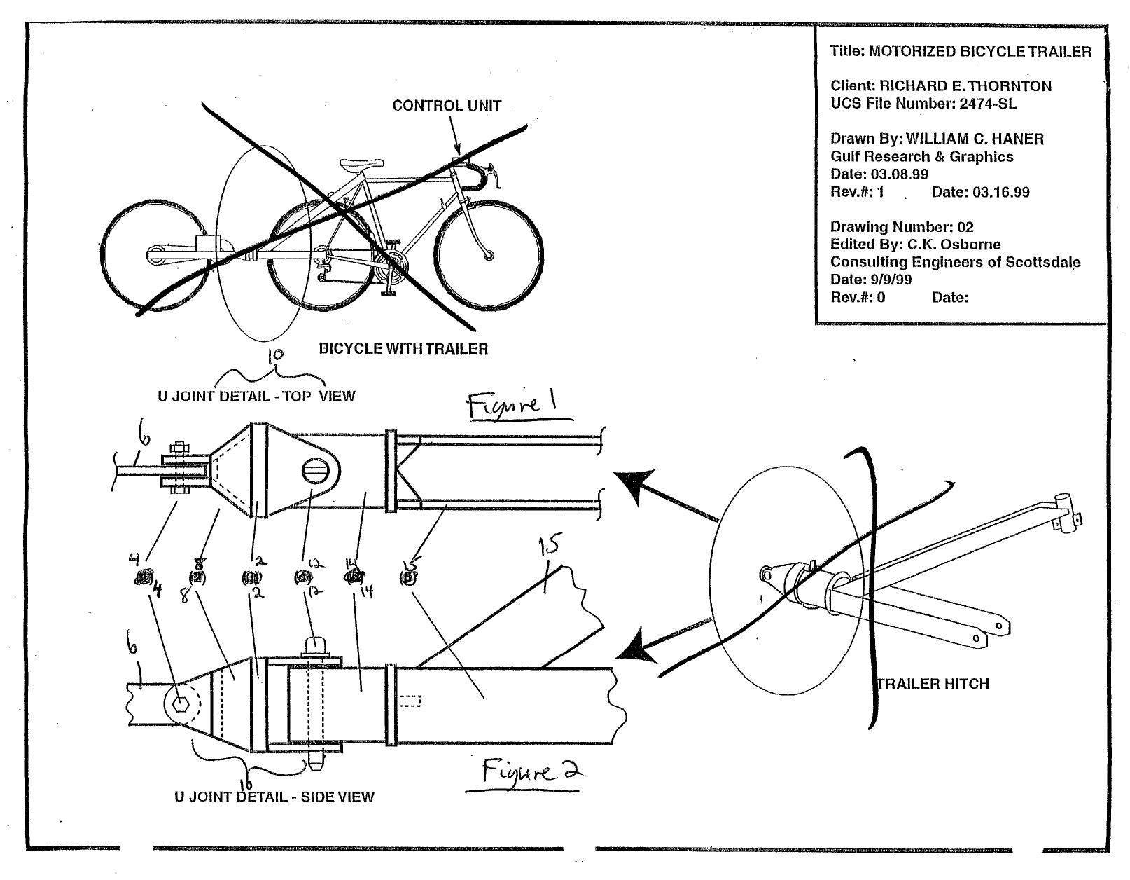

FIGS. 1 and 2 show top and side views, respectively, of U-joint 2. Motor platform 6 can be seen held in place to conical joining member 8 by shoulder bolt 4. Shoulder bolt 4 restricts rotation about the longitudinal axis while providing movement in the vertical axis. Shoulder bolt 4 is used to provide a good bearing surface while maintaining the desired mechanical stability for trailer 3.

Conical joining member 8 is attached to U-joint assembly 10. U-joint assembly 10 provides the horizontal movement of the hitch while restricting rotation about the longitudinal axis. U-joint assembly 10 is attached to transition frame member 14 by restraint pin 12, which comprises a steel pin with a ball detent restraint at the bottom end of restrain pin 12. Restraint pin 12 is a pin that is easily commercially available and can be easily inserted or withdrawn from U-joint assembly 10. The ball detent on restraint pin 12 prevents the pin from falling out when exposed to normal operating vibration. Transition frame member 14 is subsequently attached to connector bars 15, which subsequently attach to bicycle frame 16.

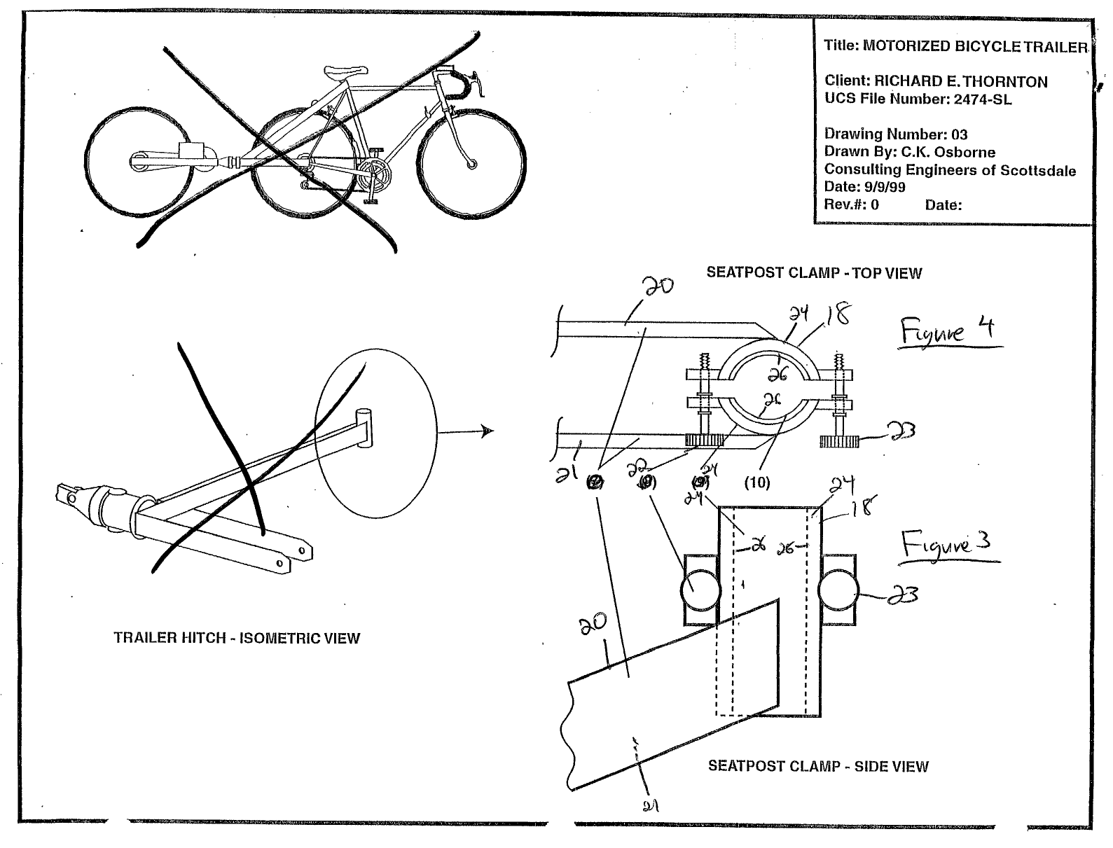

FIGS. 3 and 4 show side and top views, respectively, of seat post clamp 18. Seat post clamp 18 comprises two attachment frame members 20 and 21, which are connected to seat post clamp 18 by various means (not shown) which allows for adjustments to different types of bicycles. Each attachment frame member has a half of a seat post clamp 24 which, when placed together around a seat post, will completely surround the seat post and ensure that seat clamp 18 will remain clamped to the bicycle immediately below the seat. The inner surface of each seat post clamp 24 includes a plastic lining 26 which is adhesively bonded to the inner surface. The plastic lining 26 prevents marking or denting on the bicycle seat post as the trailer hitch is installed and allows for installation. Once the pair of seat post clamps 24 are attached to a seat post, plastic cast attachment bolts 22 and 23 are then tightened until the seat post clamp is securely attached to a seat post.

The present invention can be designed to use either a gasoline engine or an electrical motor as its power source. The gasoline engine configuration is seen in a top view in FIG. 5. The gasoline engine configuration includes motor platform 28, throttle control 30, gasoline engine 32, and gasoline tank 34. Throttle control 30 would be electronically or mechanically connected to a control panel located on the handlebars of the bicycle, thereby allowing a user to operate the gasoline engine and transmission as desired. Drive wheel 5, which is the third wheel that is added as a part of the present invention, can also be seen. Please note that the above-described power arrangements are only two possible representations of many different possible variations that the present invention could possess.

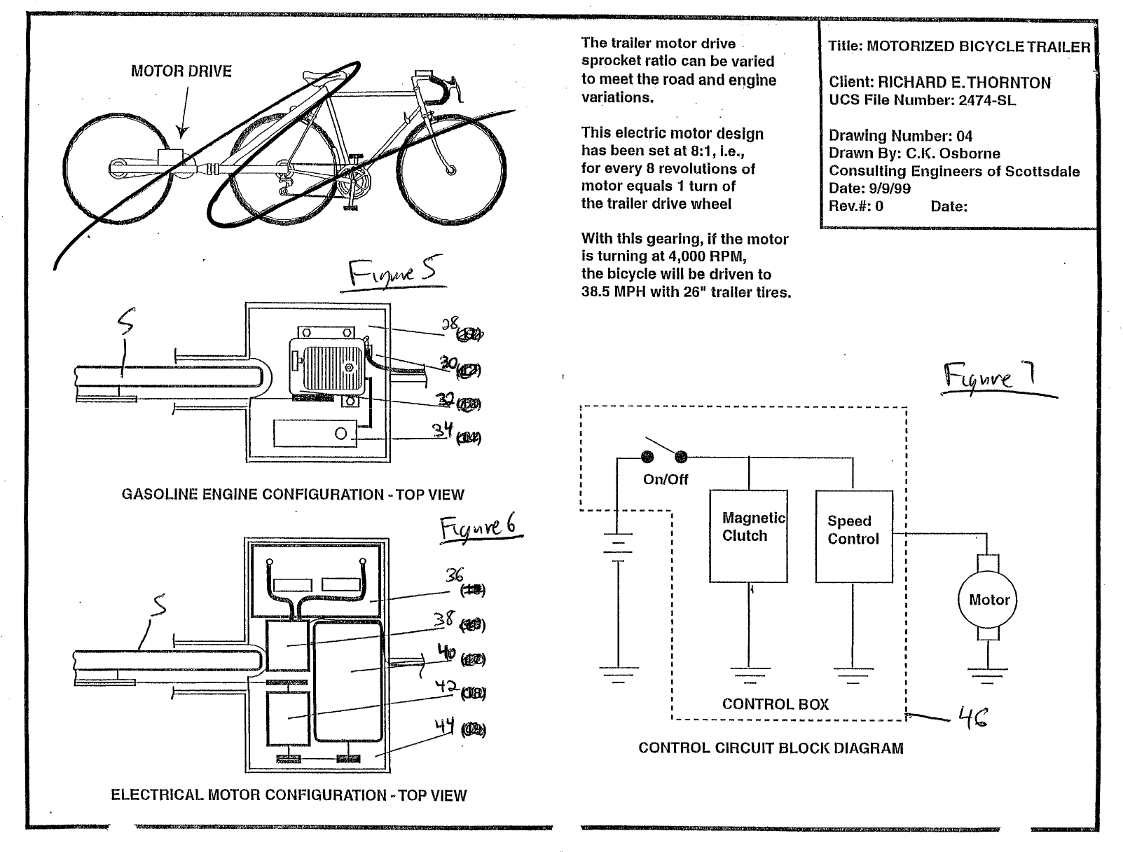

FIG. 6 is a perspective view of the electrical motor configuration. Battery 36 can be seen with motor speed control/battery charger 38, along with DC motor 40, magnetic clutch 42, and motor platform 44. Drive wheel 5 can also be seen, in contact with the electrical motor configuration, to ensure that the electrical motor would rotate drive wheel 5 when appropriate.

FIG. 7 is a schematic view of the control circuit 46 that would be located on a user's handlebars on a bicycle used with the present invention. Once a user would engage the control circuit 46 by turning the on/off switch to the “on” position, the user would then be able to engage the present invention by activating the magnetic clutch. In addition, a user would have control of the present invention by engaging the speed control to different levels. The speed control on control circuit 46 is connected directly to the motor and determines how fast the motor will function.

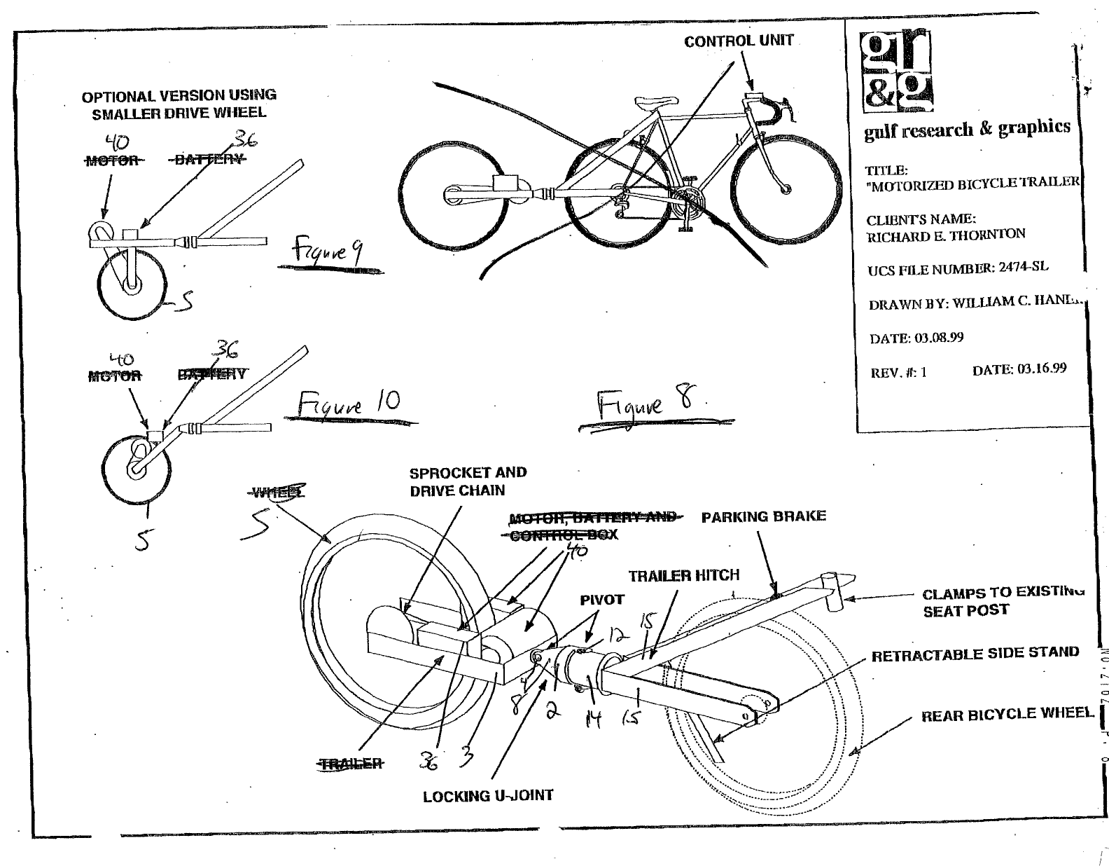

FIG. 8 is a perspective view of the entire trailer 3 of the present invention. Trailer 3 can be seen along with drive wheel 5, which is the third wheel that is added as a part of the present invention.

FIGS. 9 and 10 illustrate alternative embodiments of drive wheel 5 and associated components of the present invention. FIGS. 9 and 10 are designed to be used when a user desires to have a smaller drive wheel 5 that is currently shown in the preferred embodiment of the present invention.

What I claim as my invention is:

1. A self-propelling bicycle trailer in combination with a bicycle comprising:
a. a bicycle, the bicycle including a pair of tires, a front tire and a rear tire, the bicycle also including a frame, the frame including a seat post,
b. a trailer wheel,
c. a bicycle trailer framework
d. a first connective means for connecting the bicycle trailer framework to the frame of the bicycle,
e. a second connective means for connecting the bicycle trailer framework to the seat post of the frame of the bicycle,
f. a mechanical power source to rotate the trailer wheel, the mechanical power source being in contact with the trailer wheel,
g. a command unit to control the power source.

2. A bicycle trailer according to claim 1, wherein the power source is an electrical motor.

3. A bicycle trailer according to claim 1, wherein the power source is an internal combustion engine.
